(19) United States
(12) Patent Application Publication
(10) Pub. No.: US 2026/0244835 A1
(43) Pub. Date: Aug. 20, 2026

(54) Method and Apparatus for Determining Shape Parameter of Fluid Pathway

(71) Applicant: Robert Bosch GmbH, Stuttgart (DE)

(72) Inventors: Siliang Lu, Shanghai (CN); Xu Xie, Shanghai (CN); Hanyang Zhang, Shanghai (CN)

(21) Appl. No.: 19/161,226

(22) PCT Filed: Mar. 1, 2023
(86) PCT No.: PCT/CN2023/079005

§ 371 Date: Aug. 30, 2025

(51) Int. Cl. G06F 30/28; G06F 30/27; G06F 113/08

(52) U.S. Cl. CPC G06F 30/28; G06F 30/27; G06F 2113/08

(57) ABSTRACT

A method for determining a shape parameter of a fluid pathway includes (i) obtaining first simulation data, wherein the first simulation data is associated with characteristics of a fluid when flowing in the fluid pathway having a first shape parameter, (ii) in response to a simulation operating condition being met, providing the first simulation data to a machine learning model to obtain a second shape parameter of the fluid pathway, and (iii) providing the second shape parameter to a simulation system to obtain second simulation data, wherein the second simulation data is associated with characteristics of the fluid when flowing in the fluid pathway having the second shape parameter.

### TECHNICAL FIELD

The present disclosure relates generally to computer-aided design and, more particularly, to a method and a device for determining a shape parameter of a fluid pathway.

### BACKGROUND

Computer Aided Design (CAD) technology has been widely used in industrial manufacturing, construction, aerospace and other fields. In fluid analysis, utilizing CAD software (such as Creo) to design fluid pathways, followed by simulation analysis with Computer Aided Engineering (CAE) software (such as ANSYS Fluent), significantly enhances the efficiency of product design, production, and maintenance, resulting in substantial economic benefits.

However, in the design of a fluid pathway, a large number of shape parameters of the fluid pathway often need to be determined. During the design and simulation process using CAD and CAE software, in order to find the appropriate shape parameters, it is necessary to frequently manually modify one or more shape parameters to conduct numerous simulations. This approach can be time-consuming and labor-intensive. Additionally, due to the complexity of the relationships between parameters, designers require a certain level of experience to identify the correct direction for parameter adjustments, which further increases the challenges of the design process.

Therefore, an efficient method and device for determining the shape parameters of a fluid pathway is desirable, enabling the quick and accurate identification of the desired parameters of the fluid pathway while minimizing manual intervention.

### SUMMARY OF THE INVENTION

According to one aspect of the present disclosure, a method for determining a shape parameter of a fluid pathway is provided, comprising: obtaining first simulation data, wherein the first simulation data is associated with characteristics of a fluid when flowing in the fluid pathway having a first shape parameter; in response to simulation operating conditions being met, providing the first simulation data to a machine learning model to obtain a second shape parameter of the fluid pathway; and providing the second shape parameter to a simulation system to obtain second simulation

data, wherein the second simulation data is associated with characteristics of the fluid when flowing in the fluid pathway having the second shape parameter.

According to another aspect of the present disclosure, a device for determining a shape parameter of a fluid pathway, comprising: a memory; and a processor coupled to the memory, wherein the processor is configured to execute the method according to the present disclosure. According to yet another aspect of the present disclosure, a computer-readable medium is provided, which stores a computer program comprising instructions, wherein the instructions, when executed by a processor, cause the processor to be configured to perform the method according to the present disclosure.

According to still another aspect of the present disclosure, a device for determining a shape parameter of a fluid pathway, comprising: a module for obtaining first simulation data, wherein the first simulation data is associated with characteristics of a fluid when flowing in the fluid pathway having a first shape parameter; a module for providing the first simulation data to a machine learning model to obtain a second shape parameter of the fluid pathway in response to simulation operating conditions being met; and a module for providing the second shape parameter to a simulation system to obtain second simulation data, wherein the second simulation data is associated with characteristics of the fluid when flowing in the fluid pathway having the second shape parameter.

According to still another aspect of the present disclosure, a computer program product is provided, which comprises a plurality of instructions, wherein the instructions, when executed by a processor, cause the processor to perform the following operations: obtaining first simulation data, wherein the first simulation data is associated with characteristics of a fluid when flowing in the fluid pathway having a first shape parameter; in response to simulation operating conditions being met, providing the first simulation data to a machine learning model to obtain a second shape parameter of the fluid pathway; and providing the second shape parameter to a simulation system to obtain second simulation data, wherein the second simulation data is associated with characteristics of the fluid when flowing in the fluid pathway having the second shape parameter.

### BRIEF DESCRIPTION OF THE DRAWINGS

Various embodiments of the claimed subject matter are described by way of examples with reference to the accompanying drawings. The same reference signs are used in different accompanying drawings to denote the same or similar components.

FIG. 1 is a schematic diagram of a system 100 for determining a shape parameter of a fluid pathway using a machine learning model according to an example of the present disclosure.

FIG. 2 is a schematic diagram of determining a shape parameter of a fluid pathway in a distribution area of a bipolar plate of a fuel cell stack according to an example of the present disclosure.

FIG. 3 is a schematic diagram of determining a shape parameter of a fluid pathway in a reaction area of a bipolar plate of a fuel cell stack according to an example of the present disclosure.

FIG. 4 is a flow chart of a method 400 for determining a shape parameter of a fluid pathway using a machine learning model according to an example of the present disclosure.

FIG. 5 is a block diagram of a device 500 for determining a shape parameter of a fluid pathway according to an example of the present disclosure.

### DETAILED DESCRIPTION OF THE EMBODIMENTS

In the following description, numerous specific details are set forth to provide a thorough understanding of the examples of the present disclosure. However, those skilled in the relevant art will recognize that the present disclosure can be practiced without one or more of the specific details, or can be implemented using alternative methods, components, etc. In some examples, well-known structures and operations are not shown or described in detail to avoid unnecessarily obscuring the present disclosure.

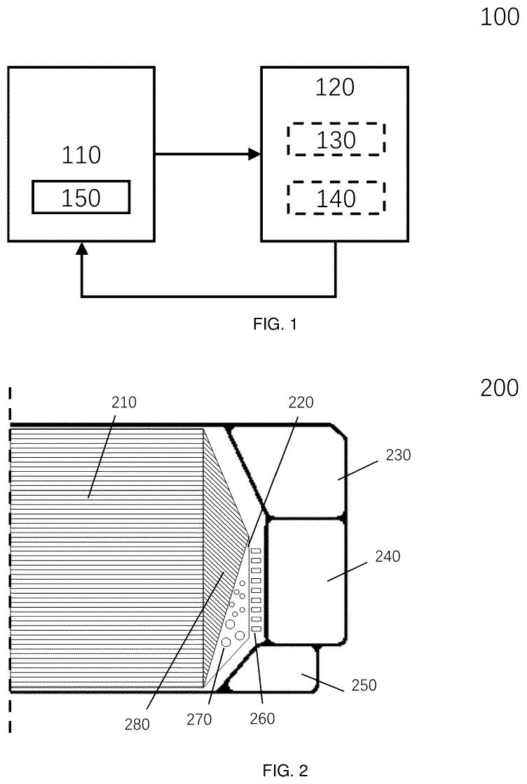

FIG. 1 is a schematic diagram of a system 100 for determining a shape parameter of a fluid pathway using a machine learning model according to an example of the present disclosure. The system 100 is composed of a machine learning model unit 110 and a simulation system 120.

The machine learning model unit 110 is used to provide a shape parameter of a fluid pathway to the simulation system 120. For example, the machine learning model unit 110 may provide a set of initial shape parameters to the simulation system 120 according to the user's instructions, and the set of initial shape parameters describes the user-defined properties related to the shape of the fluid pathway, such as the length and width of one or more flow channels, the radius of key holes in the flow channel, etc.

The simulation system 120 is used to modify the model of the fluid pathway based on the set of initial shape parameters, and perform simulation operations based on the modified model of the fluid pathway to obtain simulation data. The user may define what kind of fluid characteristic data is expected to be obtained. For example, the user may want to obtain information on the changes in pressure and temperature when the fluid flows in the flow channel. In this example, through the simulation system 120, based on the received initial shape parameters, simulation data on the pressure and temperature distribution of the fluid in the flow channel corresponding to the initial shape parameters may be obtained.

Next, the machine learning model unit 110 is used to obtain simulation data and provide the simulation data to the machine learning model 150 in response to the simulation operation conditions being met. The simulation operating conditions represent the conditions that need to be met to continue the simulation. For example, the machine learning model unit 110 may determine whether the simulation data has reached a threshold condition (such as the design requirements for pressure and temperature distribution in the flow channel). If the threshold condition has not been reached, subsequent simulation operations need to be continued. The machine learning model 150 is comprised in the machine learning model unit 110. This model employs a machine learning algorithm, such as a Bayesian optimization algorithm to calculate based on simulation data to determine updated shape parameters that may be better than the initial shape parameters. In this context, “better than” means that fluid flow characteristics that meet the user's expectations are more likely to be obtained based on the updated shape parameters than the initial shape parameters. For example, in the above example, the simulation data obtained by the user using the updated shape parameters regarding the pressure and temperature distribution of the fluid in the flow channel may be more in line with the design requirements.

Then, the machine learning model unit 110 is used to provide the updated shape parameters to the simulation system 120, and the simulation system 120 may modify the model of the fluid pathway again based on the updated shape parameters and perform simulation operations. By repeating the above process multiple times, the machine learning model unit 110 may continuously update the shape parameters provided to the simulation system 120, and then obtain the simulation data of the simulation system 120 accordingly. By accumulating and learning the simulation data, the machine learning model 110 may analyze and calculate the shape parameters provided to the simulation system 120 in the next iteration.

In one example, the simulation system 120 may further comprise a modeling unit 130 and a simulation unit 140 to perform modeling and simulation operations, respectively. For example, the machine learning model unit 110 may provide shape parameters to the modeling unit 130 to modify the shape parameters of the model of the fluid pathway. The modeling unit 130 may then import the modified model into the simulation unit 140 for simulation operations to obtain simulation data. In one example, the modeling unit 130 and the simulation unit 140 may be independent of each other and/or module units located on different computing devices. For example, the simulation unit 140 often requires more powerful computing power, so it may be run on a high-performance computer or in the cloud. It should be understood that the various components of the machine learning model unit 110 and the simulation system 120 may be arbitrarily combined on one computing device or multiple computing devices that communicate with each other without restriction.

In one example, the machine learning model unit 110 may repeatedly provide simulation data to the machine learning model 150 to obtain updated shape parameters. Therefore, the simulation operating conditions as described above may also include that the number of times the simulation data is repeatedly provided to the machine learning model 150 is less than a threshold count. For example, when the number of times the shape parameters are updated reaches a threshold count (e.g., 20 times, 25 times), the machine learning model unit 110 may stop further iterative operations.

In one example, the machine learning model 150 in the machine learning model unit 110 may also employ a neural network algorithm. In this example, the neural network may need to be trained in advance using a large number of datasets.

Compared to traditional design methods that involve manually analyzing simulation results and modifying parameters, the solution according to the examples of the present disclosure may significantly reduce the need for designer intervention in the simulation process, saving both time and resources. Additionally, by employing machine learning method to determine the direction of parameter adjustments, the parameter adjustment process is further simplified, enabling the rapid and accurate identification of shape parameters for the fluid pathway that meet design requirements.

FIG. 2 is a schematic diagram of determining a shape parameter of a fluid pathway in a distribution area of a bipolar plate of a fuel cell stack according to an example of the present disclosure.

A bipolar plate in a fuel cell stack is one of the core components for electrochemical reactions. The bipolar plate not only provides a flow channel for the reaction gas (such as hydrogen and air), but also has the functions of providing an electron pathway and supporting the stack. FIG. 2 shows the fluid inlet portion of an exemplary bipolar plate 200. For clarity, the outlet portion on the left side of the dotted line in FIG. 2 is omitted. Three fluid inlets are shown on the far right of the bipolar plate 200, wherein an air inlet 230, a coolant inlet 240, and a hydrogen inlet 250 respectively provide air, coolant (such as water), and hydrogen to a reaction area 210 of the bipolar plate. Multiple groups of flow channels arranged in parallel are arranged in the reaction area 210. Air, coolant, and hydrogen flow in their respective flow channels, and perform electrochemical reactions with the help of the membrane electrode bonded to the bipolar plate to generate electricity. One of the requirements for designing the bipolar plate is to ensure the even distribution of the reaction gas and coolant across each group of flow channels in the entire reaction area 210. This uniform distribution helps prevent a reduction in reaction efficiency caused by variations in fluid flow within the flow channels. In order to achieve this goal, a distribution area is also arranged between the fluid inlet of the bipolar plate and the reaction area 210. The layout of the distribution area 220 for the coolant is exemplarily shown FIG. 2, wherein the coolant 240 first enters the distribution area 220 through a set of inlet grids 260. Then the coolant enters corresponding guide channels 280 through guide holes 270 of different sizes, and the guide channels 280 guide the coolant to coolant flow channels located at different positions in the reaction area 210 of the bipolar plate. By adjusting the width of the grids 260 and the radius of the guide holes 270, the flow distribution of the coolant in the reaction area 210 may be uniform. It should be understood that the grids 260 and the guide holes 270 shown in FIG. 2 are only exemplary. The flow distribution of the coolant may be uniform by adjusting the size of the grids 260 and the guide holes 270 of any other shape.

In this example, the simulation system 120 shown in FIG. 1 receives a set of initial grid sizes and guide hole sizes, and the simulation system 120 modifies the model of the distribution area based on the set of parameters, and performs simulation operations based on the modified model of the distribution area to obtain simulation data. The simulation data is used to indicate the flow distribution of the fluid in the reaction area 210. Next, the machine learning model unit 110 is used to obtain the simulation data from the simulation system 120 and provide the simulation data to the machine learning model 150. The machine learning model 150 performs calculations based on the simulation data to determine the sizes of the grids 260 and the guide holes 270 that may make the flow distribution of the fluid in the reaction area 210 more uniform, and provides the updated size data to the simulation system 120 to modify the model of the distribution area again and perform simulation operations. By repeating the above process multiple times, the machine learning model unit 110 may continuously update the sizes of the grids 260 and the guide holes 270 provided to the simulation system 120, and then obtain the simulation data of the simulation system 120 accordingly. In this process, the size of the grids 260 and the guide holes 270 is continuously optimized until the number of repetitions reaches the threshold count or the standard deviation of the flow in all flow channels is less than the threshold standard deviation. Through the above method of the present disclosure, the size of the grids 260 and the guide holes 270 is automatically adjusted, thereby improving the design efficiency.

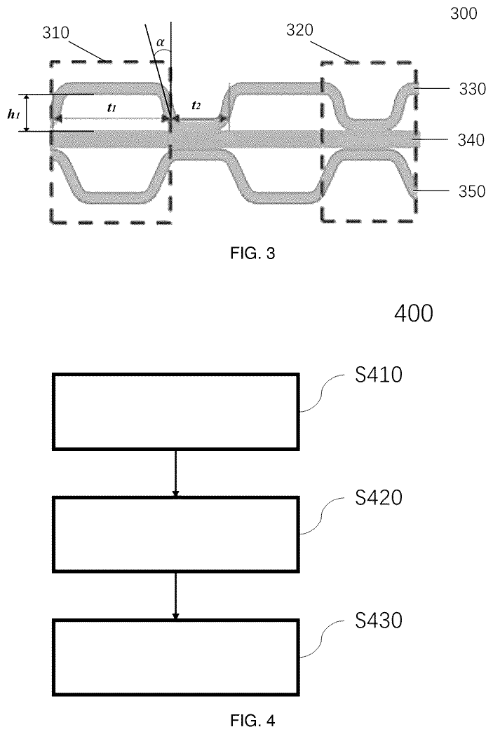

FIG. 3 is a schematic diagram of determining a shape parameter of a fluid pathway in a reaction area of a bipolar plate of a fuel cell stack according to an example of the present disclosure.

FIG. 3 shows a portion of a cross section of the reaction area of an exemplary bipolar plate 300. For example, the cross section shown in FIG. 3 may correspond to the cross section indicated by the dotted line in FIG. 2, including an anode plate 330, a membrane electrode 340, and a cathode plate 350. It should be understood that the reaction area of the fuel cell stack may comprise multiple groups of stacked bipolar plates. For clarity, FIG. 3 shows only one group of anode plate, membrane electrode, and cathode plate. In the dotted box 310, the portion enclosed by the anode plate 330 and the membrane electrode 340 is an air flow channel; the portion enclosed by the cathode plate 350 and the membrane electrode 340 is a hydrogen flow channel. The dotted box 320 shows the portion where the anode plate 330 and the cathode plate 350 fit the membrane electrode 340, which is called a ridge on each plate and is a flow channel for the coolant. In an electrochemical reaction, the dimension of the flow channel for each fluid is related to the efficiency of the reaction. In order to obtain the desired current density, the dimension of the flow channel needs to be designed. Taking the anode plate 330 as an example, the shape parameters that affect current density include the width t1 and the depth hi of the oxygen flow channel, the width t2 of the ridge, and the draft angle a of the connection between the oxygen flow channel and the ridge. It should be understood that the cathode plate 350 also has corresponding shape parameters such as flow channel width, flow channel depth, ridge width, and draft angle.

In this example, the simulation system 120 shown in FIG. 1 receives a set of initial parameters including flow channel width, flow channel depth, ridge width, and draft angle. The simulation system 120 modifies the model of the flow channel based on the set of parameters, and performs simulation operations based on the modified model of the flow channel to obtain simulation data. The simulation data is used to indicate the current density of the fuel cell stack. Next, the machine learning model unit 110 is used to obtain simulation data from the simulation system 120 and provide the simulation data to the machine learning model 150. The machine learning model 150 calculates based on the simulation data and determines flow channel width, flow channel depth, ridge width, and draft angle that may result in greater current density. It then provides this updated shape data to the simulation system 120 to modify the model of the flow channel again and perform simulation operations. By repeating the above process multiple times, the machine learning model unit 110 may continuously update the flow channel width, flow channel depth, ridge width, and draft angle provided to the simulation system 120, and then obtain the simulation data of the simulation system 120 accordingly. In this process, the flow channel width, flow channel depth, ridge width, and draft angle are continuously optimized until the number of repetitions reaches a threshold count or the current density of the fuel cell stack is greater than a threshold current density. Through the above-mentioned method disclosed in the present invention, the automatic adjustment of the flow channel width, flow channel depth, ridge width, and draft angle is achieved, thereby improving the design efficiency.

It should be understood that FIG. 2 and FIG. 3 are merely exemplary illustrations of two examples using the concept of the present disclosure. The examples of the present disclosure are not limited to the above examples, but include any other environment for designing a fluid pathway.

FIG. 4 is a flow chart of a method 400 for determining a shape parameter of a fluid pathway using a machine learning model according to an example of the present disclosure. At step S410, the method comprises obtaining first simulation data, wherein the first simulation data is associated with characteristics of a fluid when flowing in the fluid pathway having a first shape parameter. In one example, the fluid pathway is a path of a fluid in a bipolar plate of a fuel cell stack.

At step S420, the method comprises providing the first simulation data to a machine learning model in response to simulation operating conditions being met to obtain a second shape parameter of the fluid pathway. In one example, the machine learning model uses a Bayesian optimization algorithm.

At step S430, the method comprises providing the second shape parameter to a simulation system to obtain second simulation data, wherein the second simulation data is associated with characteristics of the fluid when flowing in the fluid pathway having the second shape parameter. In one example, the simulation system comprises a modeling unit and a simulation unit, and the method further comprises: providing the second shape parameter to the modeling unit, wherein the modeling unit modifies the model of the fluid pathway based on the second shape parameter, and the simulation unit simulates based on the modified model to obtain the second simulation data. In one example, the modeling unit and the simulation unit run on different computing devices. In one example, the first shape parameter and the second shape parameter comprise one or more of the following: the size of the grids through which the fluid passes when entering the distribution area, the size of the guide holes through which the fluid passes when entering the guide channels, and wherein the first simulation data and the second simulation data are associated with the flow distribution of the fluid in the reaction area. In one example, the first shape parameter and the second shape parameter comprise one or more of the following: flow channel width, flow channel depth, ridge width, draft angle, and wherein the first simulation data and the second simulation data are associated with the current density of the fuel cell stack. In one example, the method 400 further comprises providing the initial shape parameters to the simulation system to obtain the first simulation data. In one example, the simulation operating conditions comprise: the number of times the simulation data is repeatedly provided to the machine learning model is less than a threshold count, or the first simulation data does not meet the threshold condition.

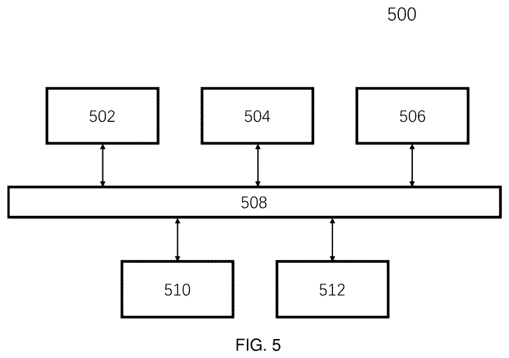

FIG. 5 is a block diagram of a device 500 for determining a shape parameter of a fluid pathway according to an example of the present disclosure. In one example, the device 500 may comprise a computing device, such as a desktop computer, a notebook computer, a minicomputer, a cloud server, and the like.

The device 500 comprises a processor 502 connected to an internal communication bus 508, wherein the processor 502 is used to execute instructions in a memory 504 to implement the method for determining the shape parameters of a fluid pathway described in detail above. Examples of the processor 502 may comprise a central processing unit (CPU), a microcontroller, etc. The memory 504 comprises various forms of memory, such as DRAM. The device 500 may further comprise an input interface 510 and an output interface 512. The input interface 510 is used to receive input signals and data from an input device (e.g., a keyboard, a mouse, etc. coupled to the computing device). The output interface 512 is used to send output signals and data to an output device (e.g., a display). Additionally, the device 500 may also comprise a non-volatile storage device 506 for tangibly storing computer program instructions and data.

The various methods, steps, operations, units, modules, components, models, and networks described in conjunction with the present disclosure may be implemented as hardware, software executed by a processor, firmware, or any combination thereof. According to one or more aspects of the present disclosure, a computer program product for determining a shape parameter of a fluid pathway may comprise processor-executable computer instructions for implementing one or more of the methods or steps described above with reference to FIG. 4. According to other aspects of the present disclosure, the computer-readable medium may store computer instructions for determining a shape parameter of a fluid pathway, wherein the instructions, when executed by the processor, cause the processor to perform one or more of the methods or steps described above with reference to FIG. 4.

Computer-readable media comprises both non-transitory computer storage media and communication media, with communication media encompassing any media that facilitate the transfer of computer programs from one location to another. Any connection may be appropriately referred to as a computer-readable medium.

In addition to the content described herein, various modifications can be made to the examples and implementations of the present disclosure without departing from the scope of the examples and implementations of the present disclosure. Therefore, the description and examples herein should be interpreted as illustrative and not restrictive. The scope of the present disclosure should only be determined by reference to the Claims.

1. A method for determining a shape parameter of a fluid pathway, comprising:
obtaining first simulation data, wherein the first simulation data is associated with characteristics of a fluid when flowing in the fluid pathway having a first shape parameter;
in response to simulation operating conditions being met, providing the first simulation data to a machine learning model to obtain a second shape parameter of the fluid pathway; and
providing the second shape parameter to a simulation system to obtain second simulation data, wherein the second simulation data is associated with characteristics of the fluid when flowing in the fluid pathway having the second shape parameter.

2. The method according to claim 1, wherein the fluid pathway is a path of a fluid in a bipolar plate of a fuel cell stack.

3. The method according to claim 2, wherein the first shape parameter and the second shape parameter comprise one or more of the following: the size of the grids through which the fluid passes when entering the distribution area, the size of the guide holes through which the fluid passes when entering the guide channels, and wherein the first simulation data and the second simulation data are associated with the flow distribution of the fluid in the reaction area.

4. The method according to claim 2, wherein the first shape parameter and the second shape parameter comprise one or more of the following: flow channel width, flow channel depth, ridge width, draft angle, and wherein the first simulation data and the second simulation data are associated with the current density of the fuel cell stack.

5. The method according to claim 1, wherein the machine learning model uses a Bayesian optimization algorithm.

6. The method according to claim 1, wherein the simulation system comprises a modeling unit and a simulation unit, and the method further comprises:
providing the second shape parameter to the modeling unit, wherein the modeling unit modifies the model of the fluid pathway based on the second shape parameter, and the simulation unit simulates based on the modified model to obtain the second simulation data.

7. The method according to claim 6, wherein the modeling unit and the simulation unit run on different computing devices.

8. The method according to claim 1, wherein the method further comprises providing the initial shape parameters to the simulation system to obtain the first simulation data.

9. The method according to claim 1, wherein the simulation operating conditions comprise: the number of times the simulation data is repeatedly provided to the machine learning model is less than a threshold count, or the first simulation data does not meet the threshold condition.

10. A device for determining a shape parameter of a fluid pathway, comprising:
a memory;
a processor coupled to the memory, the processor being configured to perform the method according to claim 1.

11. A computer-readable medium storing a computer program comprising instructions, wherein the instructions, when executed by the processor, cause the processor to be configured to perform the method according to claim 1.

12. A device for determining a shape parameter of a fluid pathway, comprising:
a module for obtaining first simulation data, wherein the first simulation data is associated with characteristics of a fluid when flowing in the fluid pathway having a first shape parameter;
a module for providing the first simulation data to a machine learning model to obtain a second shape parameter of the fluid pathway in response to simulation operating conditions being met; and
a module for providing the second shape parameter to a simulation system to obtain second simulation data, wherein the second simulation data is associated with characteristics of the fluid when flowing in the fluid pathway having the second shape parameter.

13. A computer program product comprising a plurality of instructions, wherein the instructions, when executed by a processor, cause the processor to perform the following operations:
obtaining first simulation data, wherein the first simulation data is associated with characteristics of a fluid when flowing in the fluid pathway having a first shape parameter;
in response to simulation operating conditions being met, providing the first simulation data to a machine learning model to obtain a second shape parameter of the fluid pathway; and
providing the second shape parameter to a simulation system to obtain second simulation data, wherein the second simulation data is associated with characteristics of the fluid when flowing in the fluid pathway having the second shape parameter.
